(19) United States
(12) Patent Application Publication
(10) Pub. No.: US 2020/0318538 A1
(43) Pub. Date: Oct. 8, 2020

(54) Hydrogen Hybrid Cycle System

(71) Applicant: Tascosa Advanced Services, Inc., San Antonio, TX (US)

(72) Inventor: Joshua Partheepan, Canyon, TX (US)

(21) Appl. No.: 16/787,008

(22) Filed: Feb. 10, 2020

Related U.S. Application Data
(63) Continuation-in-part of application No. 16/489,882, filed on Aug. 29, 2019.
(60) Provisional application No. 62/540,348, filed on Aug. 2, 2017.

(51) Int. Cl. F02C 3/22; F02C 1/00; F02C 3/24

(52) U.S. Cl. CPC F02C 3/22; F02C 3/24; F02C 1/00

(57) ABSTRACT

A hydrogen hybrid cycle system configured to convert heat into mechanical work by burning a H2 and an O2. The hydrogen hybrid cycle system comprises a H2 source, an O2 source, a combustion chamber, a first steam injected gas turbine, a load, a heat recovery steam generator and a water pump. The H2 source provides the H2 to the combustion chamber. The O2 source provides the O2 to the combustion chamber. The combustion chamber burns portions of the H2 and the O2. The hydrogen hybrid cycle system burns the H2 and the O2 at or near stoichiometry in the combustion chamber. The hydrogen hybrid cycle system cools the combustion chamber with at least one of a cooling steam and a water.

### CROSS-REFERENCE TO RELATED APPLICATIONS

This application claims benefit to U.S. patent application Ser. No. 14/763,467 filed on Jul. 24, 2015, 62/540,348 filed on Aug. 2, 2017, 62/542,786 filed on Aug. 8, 2017, PCT/US18/45881 filed 2018 Aug. 8.

### STATEMENT REGARDING FEDERALLY SPONSORED RESEARCH OR DEVELOPMENT (IF APPLICABLE)

Not applicable.

### REFERENCE TO SEQUENCE LISTING, A TABLE, OR A COMPUTER PROGRAM LISTING COMPACT DISC APPENDIX (IF APPLICABLE)

Not applicable.

### BACKGROUND OF THE INVENTION

The present invention is a system for burning hydrogen (H2) and oxygen (O2) to provide power or propulsion. It can comprise a system that operates in a closed loop by combustion hydrogen at stoichiometry or near stoichiometry to produce steam. Steam drives a turbine to convert the heat energy into mechanical energy which can be used for useful work. In specific configurations, the invention allows for operation at various pressures, temperatures and load efficiently, making the system a flexible, economical, and pollution-free power generation source for electric utilities and large-scale locomotives.

Hydrogen has been known for its combustible nature since 1650, when it was described as “inflammable air.” Hydrogen as a fuel has unique properties and is significantly different from all other commonly-used hydrocarbon liquid and gas fuels; it is extremely flammable, and often described as the most flammable of all known substances.

Hydrogen is not often used in a combustion process for energy conversion, but rather used in fuel cells to produce electrical energy. Hydrogen fuel cells are efficient, but expensive, and sensitive to load fluctuations, operational environment, and fuel impurities. Hydrogen combustion for power generation can be an alternative to fuel cells, but the key challenges with hydrogen combustion for energy conversion are to ensure operational safety of the process and to reduce its complexity and cost.

Combustion of said H2 and said O2 at stoichiometry produces a high-temperature flame which results in steam and unburnt gasses. This unique property of hydrogen oxygen combustion can be used to generate steam by mixing the hot combustion resultant with said water or steam to regulate the resultant steam temperature as desired.

A device which burns H2 and/or O2 at stoichiometry for steam generation, described as an “aphodid burner,” was patented in 1967 by Oklahoma State University. Several papers were written about it in the early 1970s. The German Aerospace Center (DLR) and the Institute of Combustion Aerothermics Reactivity and Environment (ICARE) in France collaborated to study several configurations of hydrogen-oxygen combustion-based steam generators for power generation. These used several different configurations of said water injection into the steam generators. The DLR and ICARE have also collaborated to design and patent a steam generator for sterilization purposes in the pharmaceutical industry.

Several thermodynamic cycle models were proposed after the invention of hydrogen-oxygen combustion-based steam generators. Models of H2 and/or O2 combustion for power generation are disclosed in U.S. Pat. Nos. 3,459,953, 4,148,185, 5,331,806, 5,644,911, 5,687,559, 5,775,091, 5,782,081, 5,809,768, 6,021,569, 6,263,568 B1, 6,282,883 B1, 7,546,732 B2, 8,169,101 B2, 20050223711 A1, 20043435 A1, 20314878 A1, 20175638 A1. However, the current patent application presents a different and unique design.

None of the known inventions and patents, taken either singularly or in combination, is seen to describe the instant disclosure as claimed.

### BRIEF SUMMARY OF THE INVENTION

A hydrogen hybrid cycle system configured to convert heat into mechanical work by burning a H2 and an O2. Said hydrogen hybrid cycle system comprises a H2 source, an O2 source, a combustion chamber, a first steam injected gas turbine, a load, a heat recovery steam generator and a water pump. Said H2 source provides said H2 to said combustion chamber. Said O2 source provides said O2 to said combustion chamber. Said combustion chamber burns portions of said H2 and said O2. Said hydrogen hybrid cycle system burns said H2 and said O2 at or near stoichiometry in said combustion chamber. Said hydrogen hybrid cycle system cools said combustion chamber with at least one of a cooling steam and a water. Said combustion chamber creates a generated steam. Said generated steam turns said first steam injected gas turbine. Said first steam injected gas turbine is coupled said load.

A power generation method for producing useful work through said hydrogen hybrid cycle system includes following stages, or components: a combustion step, a steam generation step, a driving turbine step, a generating power step, a generating cooling steam step and a cooling stream for combustion step. Said combustion step comprises receiving said H2 in said combustion chamber, receiving said O2 in said combustion chamber, and burning portions of said H2 and said O2 in said combustion chamber. Said steam generation step comprises cooling said combustion chamber with said cooling steam and said water, and generating said generated steam. Said driving turbine step comprises driving said first steam injected gas turbine with said generated steam. Said generating power step comprises generating said cooling steam with said heat recovery steam generator, and delivering said cooling steam from said heat recovery steam generator to said combustion chamber through a one or more cooling steam passages. Said generating cooling steam step comprises cooling said combustion chamber with said cooling steam. Said hydrogen hybrid cycle system comprises said H2 source, said O2 source, said combustion chamber, said first steam injected gas turbine, said heat recovery steam generator, said water pump, and said load. Said H2 source provides said H2 to said combustion chamber. Said O2 source provides said O2 to said combustion chamber. Said combustion chamber burns portions of said H2 and said O2. Said hydrogen hybrid cycle system burns said H2 and said O2 at or near stoichiometry in said combustion chamber. Said hydrogen hybrid cycle system cools said combustion chamber with said cooling steam and said water. Said combustion chamber creates said generated steam. Said first steam injected gas turbine is coupled with said load. Said combustion chamber receives said H2 from said H2 source through a H2 passage, said O2 from said O2 source through an O2 passage, said water from a water reservoir through a water reservoir passage, and said cooling steam from said heat recovery steam generator through a steam passage.

### BRIEF DESCRIPTION OF THE SEVERAL VIEWS OF THE DRAWING

FIG. 1 illustrates block diagram view of a hydrogen hybrid cycle system 100.

FIG. 2 illustrates block diagram view of a hydrogen hybrid cycle system 100.

FIG. 3 illustrates block diagram view of a hydrogen hybrid cycle system 100.

FIG. 4 illustrates block diagram view of a detailed cycle system 200.

FIG. 5 illustrates a flow chart view of a power generation method 500.

### DETAILED DESCRIPTION OF THE INVENTION

These parts are illustrated in the figures and discussed below:
a hydrogen hybrid cycle system 100
a H2 source 102
an O2 source 104
a combustion chamber 106
a first steam injected gas turbine 108
a load 110
a heat recovery steam generator 112
a deaerator 114
a water reservoir 116
a water pump 118
a H2 passage 120
an O2 passage 122
a first water passage 124
a steam passage 126
a generated steam passage 128
a turbine exit steam passage 130
a residual steam passage 132
an unburnt gas vent passage 134
a water reservoir passage 136
a bleed water passage 138
a second water passage 140
a H2 142
an O2 144
a cooling steam 146
a low temp cooling steam 146a
a medium temp cooling steam 146b
a high temp cooling steam 146c
a water 148
a pressurized water 150
a generated steam 152
a residual steam 154
a hydrogen pump 156
an oxygen pump 158
a water to heat recovery steam generator passage 160
an unburnt gas 162
a turbine exit steam 164
a detailed cycle system 200
a steam water mixer 202
a feed water cooler 204
a pressurized water streams 206
a first pressurized water stream 206a
a second pressurized water stream 206b
a multi-stage turbines 208
a multi-temperature cooling steams 210
a first temperature cooling steam 210a
a second temperature cooling steam 210b
a third temperature cooling steam 210c
a mixed steam water 212
a feed water to feed water cooler input passage 214
a feed water to feed water cooler output passage 216
a third water passage 218
a mixed steam passage 220
a one or more cooling steam passages 302
a first cooling steam passage 302a
a second cooling steam passage 302b
a third cooling steam passage 302c
a water passage 304
a one or more steam to steam water mixer passages 306
a first steam to steam water mixer passage 306a
a second steam to steam water mixer passage 306b
a third steam to steam water mixer passage 306c
a mixed steam water passage 308
a passage 402
a reheat steam passage 404
a reduced steam to combustion chamber passage 408
a reheated steam 410
a reduced steam 412
a bypass steam passage 414
a second steam injected gas turbine 416
a power generation method 500
a combustion step 502
a steam generation step 504
a driving turbine step 506
a generating power step 508
a generating cooling steam step 510
a cooling stream for combustion step 512

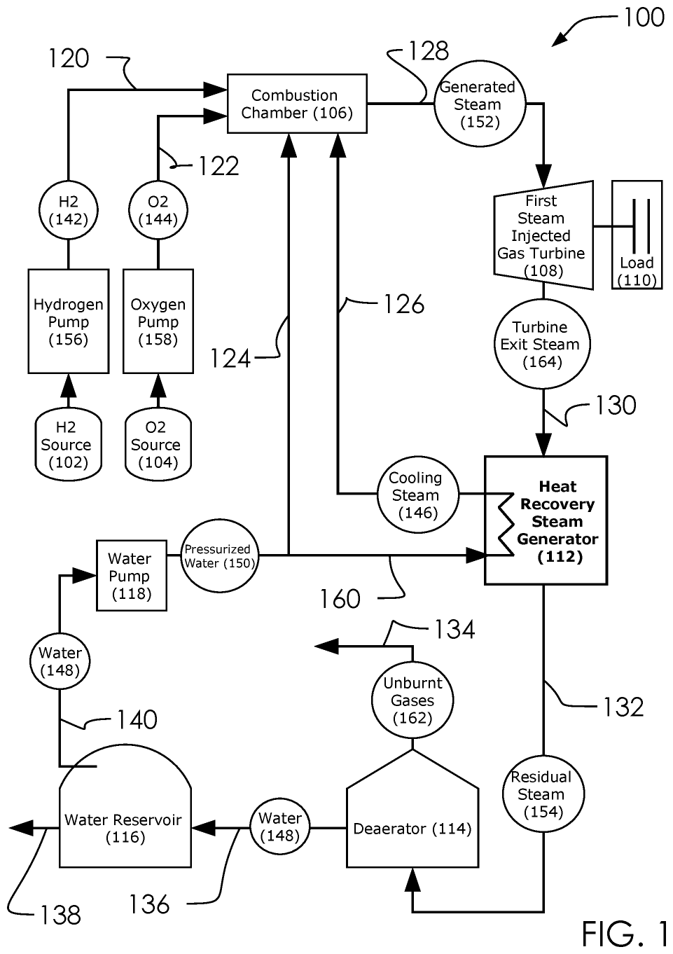

FIG. 1 illustrates block diagram view of said hydrogen hybrid cycle system 100.

In one embodiment, said hydrogen hybrid cycle system 100 can comprise said H2 source 102, said O2 source 104, said combustion chamber 106, said first steam injected gas turbine 108, said load 110, said heat recovery steam generator 112, said deaerator 114, said water reservoir 116, said water pump 118, said steam passage 126, said generated steam passage 128, said turbine exit steam passage 130, said residual steam passage 132, said unburnt gas vent passage 134, said water reservoir passage 136, said bleed water passage 138, said second water passage 140, said H2 142, said O2 144, said cooling steam 146, said water 148, said pressurized water 150, said generated steam 152, said residual steam 154, said hydrogen pump 156, said oxygen pump 158, said water to heat recovery steam generator passage 160, said unburnt gas 162 and said turbine exit steam 164.

In one embodiment, said cooling steam 146 can comprise said low temp cooling steam 146a, said medium temp cooling steam 146b and said high temp cooling steam 146c.

Note that the simplified block diagram represents a minimalistic version of said hydrogen hybrid cycle system 100. Many of the elements illustrated in FIG. 1 are described and illustrated in more detail below.

In one embodiment, said hydrogen hybrid cycle system 100 can comprise said H2 source 102, said O2 source 104, said combustion chamber 106, said first steam injected gas turbine 108, said heat recovery steam generator 112, said deaerator 114, said water reservoir 116 and said water pump 118.

In one embodiment, said H2 source 102 can be hydrogen in gaseous phase stored under pressure in gas cylinders, or containers. Said H2 source 102 can comprise hydrogen stored in large scale in geological storage. Said H2 source 102 can comprise hydrogen stored in indirect form, i.e. metal hydrides. Said H2 source 102 can comprise hydrogen from industrial processes. Said H2 source 102 can comprise hydrogen stored in liquid phase.

In one embodiment, said H2 source 102 can comprise a hydrogen comprising an impurity ratio. Said impurity ratio comprises an industrial standard of ninety-nine point nine percent pure hydrogen; wherein, said hydrogen hybrid cycle system can be configured to accommodate said impurity ratio being below said industrial standard depending on a final temperature, a pressure, a quality and a usage of a generated steam by a combustion chamber. In another embodiment, said hydrogen hybrid cycle system 100 can accommodate some impurities in said H2 source 102, depending on the final temperature and pressure of said generated steam 152 and the tolerance of said first steam injected gas turbine 108 towards impurities.

In one embodiment, said H2 source 102 can supply said H2 142 under pressure to said combustion chamber 106. Where said H2 source 102 comprises a low-pressure, said hydrogen pump 156 can be used to attain necessary pressure of said H2 142 for operation before entering said combustion chamber 106.

Said H2 source 102 is fed into said combustion chamber 106 through said H2 passage 120.

In one embodiment, said O2 source 104 can be said O2 144 in gaseous phase stored under pressure in gas cylinders, or containers. said O2 source 104 can comprise oxygen stored in large scale in geological storage. said O2 source 104 can comprise oxygen from industrial processes. said O2 source 104 can comprise oxygen stored in liquid phase. said O2 source 104 can comprise an oxygen purity which can comprise an industrial grade. In one embodiment, said hydrogen hybrid cycle system 100 can accommodate some impurities depending on the final temperature and pressure of said generated steam 152 and the tolerance of said first steam injected gas turbine 108 towards impurities.

In one embodiment, said O2 source 104 will supply said O2 144 under pressure to said combustion chamber 106. If 104/comprises low-pressure oxygen, said oxygen pump 158 can be used to attain the necessary pressure of oxygen for operation before entering said combustion chamber 106.

In one embodiment, said O2 144 can be fed into said combustion chamber 106 through said O2 passage 122.

In one embodiment, said water reservoir 116 contains said water 148 being demineralized with additives in accordance with industrial standards or requirements for said first steam injected gas turbine 108 and/or said heat recovery steam generator 112.

In one embodiment, said water 148 is pumped into said combustion chamber 106 through said second water passage 140 and said first water passage 124, as illustrated.

In one embodiment, said heat recovery steam generator 112 creates said cooling steam 146. In one embodiment, said cooling steam 146 is delivered to said combustion chamber 106 through said steam passage 126.

In one embodiment, said combustion chamber 106 receives said H2 142, said O2 144, said cooling steam 146, said pressurized water 150 and said generated steam 152.

In one embodiment, said combustion chamber 106 is configured to: (1) burn said H2 142 and said O2 144 at or near stoichiometry, (2) include said cooling steam 146 and said pressurized water 150 and/or a mixture of both as a coolant. In one embodiment, inclusion of said pressurized water 150 and/or said cooling steam 146 can be selected depending on a configuration of said combustion chamber 106 and availability of said pressurized water 150 or said cooling steam 146.

The temperature of said generated steam 152, created by said combustion chamber 106, depends on a flow and temperature of said pressurized water 150 and said cooling steam 146 entering said combustion chamber 106.

Said combustion chamber 106 can utilize any suitable type of combustion strategy, depending on the application and operational circumstances.

In one embodiment, said first steam injected gas turbine 108 receives said generated steam 152 through said generated steam passage 128.

In one embodiment, said generated steam 152 can selectively turn one or more turbines in said first steam injected gas turbine 108, and consequently produces useful outputs, such as electricity, as is known in the art.

In one embodiment, said turbine exit steam 164 reaches said heat recovery steam generator 112 through said turbine exit steam passage 130.

In one embodiment, said turbine exit steam 164 can be low in pressure, but high in temperature; wherein, energy which is found in said turbine exit steam 164 can be harnessed in said heat recovery steam generator 112 and used to convert said pressurized water 150 into said cooling steam 146. In one embodiment, said cooling steam 146 can be high-pressure. In one embodiment, said cooling steam 146 and said residual steam 154 do not commingle with each other.

In one embodiment, said residual steam 154 can comprise condensate from said heat recovery steam generator 112. Said condensate can reach said deaerator 114 through said residual steam passage 132. Said unburnt gas 162 are separated in said deaerator 114 and safely released into the atmosphere through said unburnt gas vent passage 134. Said water 148 can then be collected and stored in said water reservoir 116.

In one embodiment, said water 148 from said deaerator 114 can reach said water reservoir 116 through said water reservoir passage 136.

In one embodiment, said water reservoir 116 can be configured to store said water 148 for reuse in said hydrogen hybrid cycle system 100. Depending on the needs of an installation of said hydrogen hybrid cycle system 100, portions of said water 148 can exit said water reservoir 116 through said bleed water passage 138 and be used for additional purposes, including drinking, agriculture, or industrial processes.

In one embodiment, said water pump 118 can pump said water 148 from said water reservoir 116. Said pressurized water 150 can be divided and then fed into said heat recovery steam generator 112 and said combustion chamber 106 through said water to heat recovery steam generator passage 160 and said first water passage 124, respectively.

In one embodiment, pressure loss (in said combustion chamber 106, said first steam injected gas turbine 108 and said heat recovery steam generator 112), along with the maximum working pressure of steam in said hydrogen hybrid cycle system 100 can be used to determine a pressure of said pressurized water 150 to be delivered from said water pump 118.

In one embodiment, pressure loss in said heat recovery steam generator 112, said first water passage 124, said steam passage 126 and said water to heat recovery steam generator passage 160, along with the maximum working pressure of steam in said hydrogen hybrid cycle system 100 can be used to determine a pressure of said pressurized water 150 to be delivered from said water pump 118.

In one embodiment, said water 148 that enters said heat recovery steam generator 112 can be converted into said cooling steam 146 (which can comprise high-pressure) by transferring heat from said turbine exit steam 164 (which can comprise low-pressure, high-temperature). In one embodiment, said cooling steam 146 from said heat recovery steam generator 112 can be fed into said combustion chamber 106 through said steam passage 126.

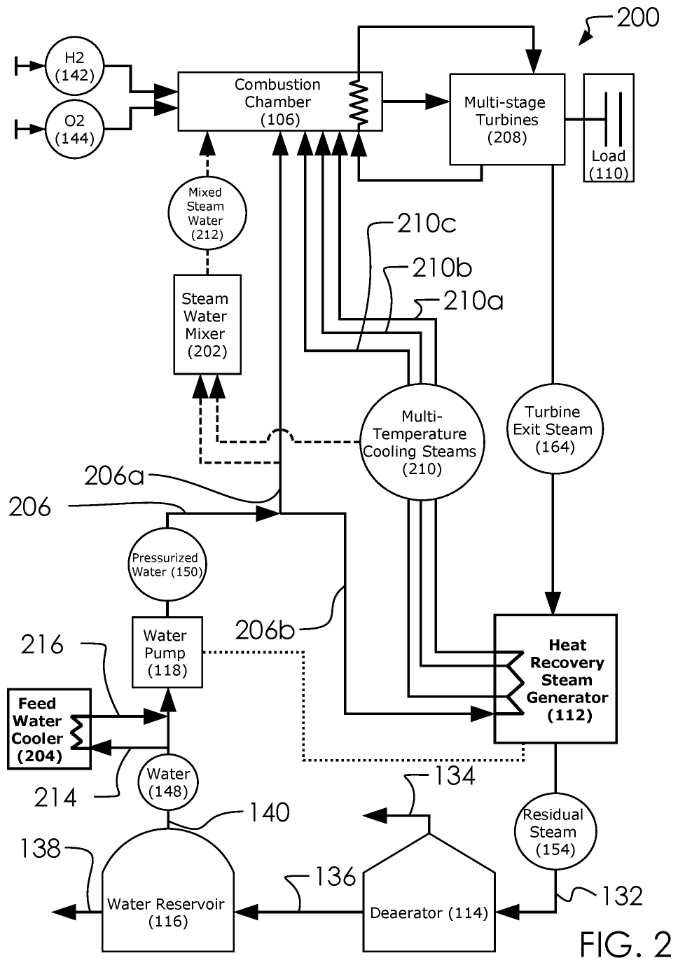

FIG. 2 illustrates block diagram view of said hydrogen hybrid cycle system 100.

In one embodiment, said pressurized water streams 206 can comprise said first pressurized water stream 206a and said second pressurized water stream 206b.

In one embodiment, said feed water cooler 204 can comprise feed said water 148 to said feed water to feed water cooler input passage 214 and said feed water to feed water cooler output passage 216.

In one embodiment, said multi-temperature cooling steams 210 can comprise said first temperature cooling steam 210a, said second temperature cooling steam 210b and said third temperature cooling steam 210c.

In one embodiment, said hydrogen hybrid cycle system 100 can comprise said feed water cooler 204 and said multi-stage turbines 208.

In one embodiment, said cooling steam 146 can comprise said multi-temperature cooling steams 210 and said mixed steam water 212.

In one embodiment, said water 148 can comprise said steam water mixer 202 and said pressurized water streams 206.

Said detailed cycle system 200 can comprise a more detailed version of said hydrogen hybrid cycle system 100.

In one embodiment, said detailed cycle system 200 can comprise said heat recovery steam generator 112, said steam water mixer 202, said feed water cooler 204 and said multi-stage turbines 208. Said heat recovery steam generator 112 in said detailed cycle system 200 can comprise a multi-temperature, elevated pressure configuration.

In one embodiment, said heat recovery steam generator 112 can deliver said multi-temperature cooling steams 210 which can comprise said cooling steam 146 at two or more different temperatures. In one embodiment, said multi-temperature cooling steams 210 can be configured to maximize heat recovery from said turbine exit steam 164. In one embodiment, said turbine exit steam 164 can comprise low-pressure, high-temperature steam.

In one embodiment, said heat recovery steam generator 112 can also produce variable-pressure, variable-temperature steam, if it is required by said combustion chamber 106 to increase performance and flexibility of said hydrogen hybrid cycle system 100 to integrate different tasks. In one embodiment, a plurality of said water pump 118 can be added to said hydrogen hybrid cycle system 100 to regulate different pressures in said multi-temperature cooling steams 210.

In one embodiment, said feed water cooler 204 can be optional. In one embodiment, said feed water cooler 204 can be installed to cool said water 148 before being pumped by said water pump 118 to operate said hydrogen hybrid cycle system 100 at optimum efficiency.

Said water 148 from said water reservoir 116 can enter said feed water cooler 204 using said feed water to feed water cooler input passage 214 and can exit using said feed water to feed water cooler output passage 216. Said feed water to feed water cooler input passage 214 can capture a portion of said water 148 flowing through said second water passage 140. Said feed water to feed water cooler output passage 216 can return a portion of said water 148 back to said second water passage 140 after passing through said feed water cooler 204.

In one embodiment, said feed water cooler 204 can be air-cooled, water-cooled, hydrogen cooled, oxygen cooled, or a combination of different coolants depending on the location, availability of resources and temperature difference of said feed water to feed water cooler input passage 214 and said feed water to feed water cooler output passage 216.

In one embodiment, said H2 142 and said O2 144 enter said combustion chamber 106. A flowrate of said H2 142 and said O2 144 are measured and regulated to attain a stoichiometry or near-stoichiometry ratio. Said H2 142 and said O2 144 can be injected into said combustion chamber 106 and safely ignited. A flame resulting from burning said H2 142 and said O2 144 can result in a steam and an energy released in the form of very high temperature heat.

In one embodiment, cooling said generated steam 152, said hydrogen hybrid cycle system 100 is provided with said pressurized water 150, said multi-temperature cooling steams 210 and said mixed steam water 212 which can be injected into said combustion chamber 106.

In one embodiment, a flame resulting from burning said H2 142 and said O2 144 at stoichiometry or near-stoichiometry ratio can result in a steam and an energy released in the form of very high temperature heat, in order to reduce very high temperature heat generated cooling arrangements are available. said hydrogen hybrid cycle system 100 cooling system is provided with said pressurized water 150, said multi-temperature cooling steams 210 and said mixed steam water 212 which can be injected into said combustion chamber 106 to generate said generated steam 152.

In one embodiment, a temperature of said generated steam 152 can depend on a flow rate, temperature and pressure of the inputs of said combustion chamber 106 (such as said H2 142, said O2 144, said pressurized water 150, said multi-temperature cooling steams 210 and said mixed steam water 212). said hydrogen hybrid cycle system 100 can comprise a controller and a plurality of sensors for measuring such inputs.

In one embodiment, said combustion chamber 106 can be configured to minimize hot spots in said unburnt gas 162 in said residual steam 154. It can also be designed to handle said multi-temperature cooling steams 210.

In one embodiment, said turbine exit steam 164 can be very hot; wherein, said heat recovery steam generator 112 can harness waste energy and thereby convert said pressurized water 150 into said cooling steam 146 or said multi-temperature cooling steams 210 depending on the configuration.

Said steam water mixer 202 can be used to mix said cooling steam 146, said pressurized water 150 and said multi-temperature cooling steams 210 to increase combustion and mixing efficiency at said combustion chamber 106. Said steam water mixer 202 can be configured to control portions of said cooling steam 146, said pressurized water 150 and said multi-temperature cooling steams 210 to be included in said mixed steam water 212. Said steam water mixer 202 can be configured to optimize temperature, pressure and flow rate of said multi-temperature cooling steams 210 from said heat recovery steam generator 112.

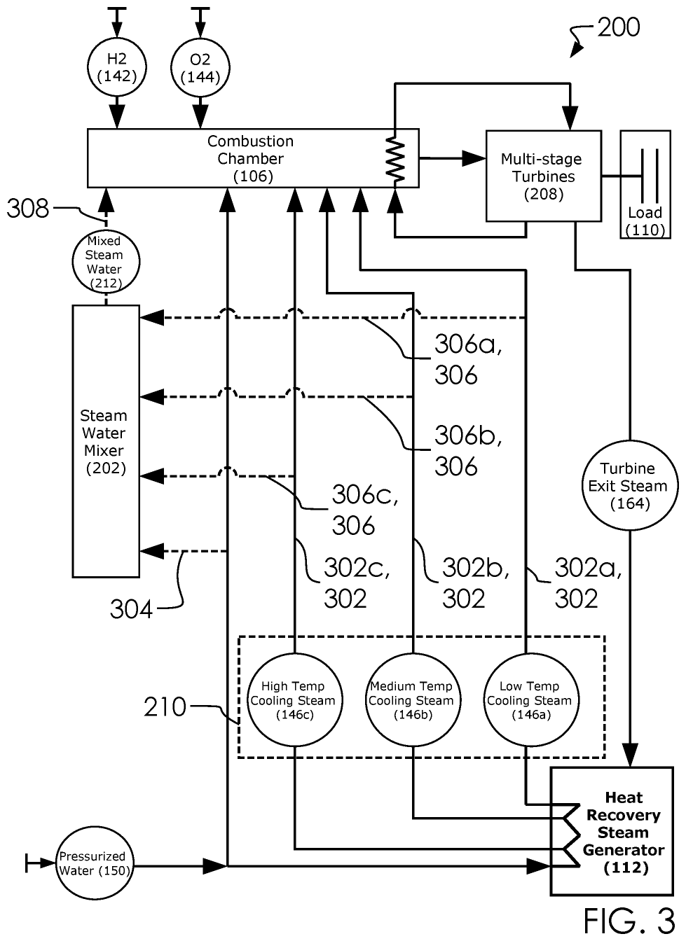

FIG. 3 illustrates block diagram view of said hydrogen hybrid cycle system 100.

In one embodiment, said one or more cooling steam passages 302 can comprise said first cooling steam passage 302a, said second cooling steam passage 302b and said third cooling steam passage 302c.

In one embodiment, said one or more steam to steam water mixer passages 306 can comprise said first steam to steam water mixer passage 306a, said second steam to steam water mixer passage 306b and said third steam to steam water mixer passage 306c.

In one embodiment, said detailed cycle system 200 can comprise said water passage 304, said one or more steam to steam water mixer passages 306 and said mixed steam water passage 308.

In one embodiment, said cooling steam 146 can comprise said one or more cooling steam passages 302.

In one embodiment, said multi-temperature cooling steams 210 can comprise said low temp cooling steam 146a, said medium temp cooling steam 146b and said high temp cooling steam 146c.

In one embodiment, said multi-temperature cooling steams 210 can be passed to said combustion chamber 106 using said one or more cooling steam passages 302; namely, said low temp cooling steam 146a using Said first cooling steam passage 302a, said medium temp cooling steam 146b using said second cooling steam passage 302b, and said third cooling steam passage 302c using said high temp cooling steam 146c.

In one embodiment, said low temp cooling steam 146a can comprise a low temperature, said medium temp cooling steam 146b can comprise an intermediate temperature and said high temp cooling steam 146c can comprise a high temperature, as compared with one another.

In one embodiment, said multi-temperature cooling steams 210 can be adjusted, with regard to temperature and flow rate, depending on the optimum design and heat extraction rate of said heat recovery steam generator 112, and can vary according to conditions of said load 110.

In one embodiment, to increase the operational performance of said combustion chamber 106, said multi-temperature cooling steams 210 can be mixed with said pressurized water 150 in said steam water mixer 202 prior to entering said combustion chamber 106. Said first temperature cooling steam 210a can be selectively delivered to said steam water mixer 202 through said one or more steam to steam water mixer passages 306; namely, said low temp cooling steam 146a using Said first steam to steam water mixer passage 306a, said medium temp cooling steam 146b using said second steam to steam water mixer passage 306b, and said high temp cooling steam 146c using said third steam to steam water mixer passage 306c. Likewise, a portion of said pressurized water 150 can be delivered to said steam water mixer 202 through said water passage 304.

In one embodiment, said pressurized water 150 can be misted and/or vaporized in said steam water mixer 202 to form said mixed steam water 212. Said mixed steam water 212 can increase a thermal efficiency of a combustion process and reduce hotspots through more uniform mixing of said multi-temperature cooling steams 210 and said pressurized water 150 into said mixed steam water 212 and the combustion product in said combustion chamber 106.

In one embodiment, said steam water mixer 202 can be configured to uniformly mix said cooling steam 146 and said pressurized water 150, and thereby reduce cold spots in said mixed steam water 212 entering said combustion chamber 106. Said mixed steam water 212 can enter said combustion chamber 106 through said mixed steam water passage 308.

In one embodiment, a portion of said multi-temperature cooling steams 210 can pass directly into said combustion chamber 106 through said one or more cooling steam passages 302, and a remaining portion of said multi-temperature cooling steams 210 can pass through said one or more steam to steam water mixer passages 306 into said steam water mixer 202.

In one embodiment, the amount of said pressurized water 150 and said multi-temperature cooling steams 210 entering said steam water mixer 202 depends on the flow rates, temperature and pressure of said pressurized water 150 and said multi-temperature cooling steams 210.

In one embodiment, the portions of said pressurized water 150 and said multi-temperature cooling steams 210 entering said combustion chamber 106 and said steam water mixer 202 is optimized depending to various operational parameters in said hydrogen hybrid cycle system 100 to meet requirements of said combustion chamber 106 with regards to safe and efficient operation at maximized cycle performance

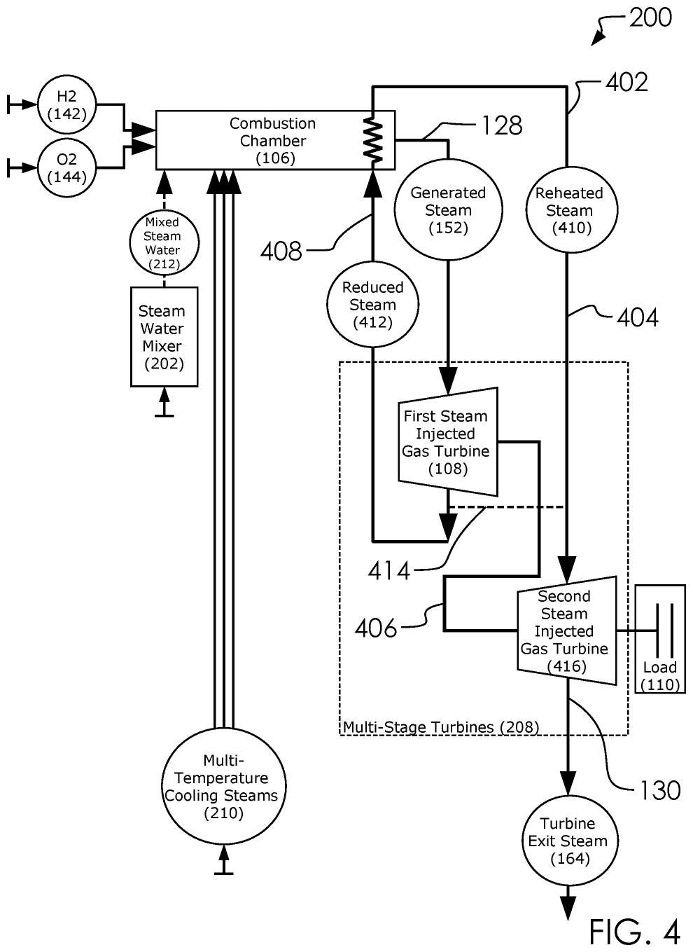

FIG. 4 illustrates block diagram view of a said detailed cycle system 200.

In one embodiment, said hydrogen hybrid cycle system 100 can comprise said reheated steam 410, said reduced steam 412 and said bypass steam passage 414.

In one embodiment, said multi-stage turbines 208 can comprise said first steam injected gas turbine 108, said passage 402, said reheat steam passage 404, and said reduced steam to combustion chamber passage 408.

In one embodiment, can comprise said multi-stage turbines 208.

said multi-stage turbines 208 can comprise said first steam injected gas turbine 108 and said second steam injected gas turbine 416.

In one embodiment, said reduced steam 412 can comprise a steam in between stages. Said reduced steam 412 can be bled and reheated in said combustion chamber 106 to said reheated steam 410, and then reinjected into said multi-stage turbines 208, to increase output and efficiency of operation of said hydrogen hybrid cycle system 100.

In one embodiment, said multi-stage turbines 208 can receive said generated steam 152 (which can comprise high-pressure, high-temperature steam) from said combustion chamber 106 through said generated steam passage 128. Said generated steam 152 can then be reduced to a specified pressure and temperature, and re-fed into said combustion chamber 106 through said reduced steam to combustion chamber passage 408 as said reduced steam 412. Said reduced steam 412 can be injected back into said said combustion chamber 106 for reheating and become said reheated steam 410 which passes through said passage 402 from said combustion chamber 106. Said reheated steam 410 (intermediate pressure high temperature steam) can be injected into said multi-stage turbines 208 at said second steam injected gas turbine 416 through said reheat steam passage 404. In one embodiment, for operational flexibility in different configurations and loading conditions, said reduced steam 412 can bypass reheating in said combustion chamber 106 be injected directly into said second steam injected gas turbine 416 through said bypass steam passage 414.

In summary, said hydrogen hybrid cycle system 100 can form forms a simple closed loop system with higher operating efficiency and lower capital cost than conventional designs. Said hydrogen hybrid cycle system 100 can have the added benefit of zero operational pollution.

In one embodiment, said hydrogen hybrid cycle system 100 can be useful for power generation, in locomotives for propulsion, and in combined heat and power applications.

In one embodiment, said hydrogen hybrid cycle system 100 can work alongside conventional burners in steam- or gas-turbine power plants to generate power at reduced or zero pollution, provided that the hydrogen is generated from or through renewable energy sources. said hydrogen hybrid cycle system 100 can also be accommodated in a conventional coal or gas turbine or nuclear power plant with minor changes to generate electricity with reduced pollution and increased efficiency.

In one embodiment, said hydrogen hybrid cycle system 100 can work along with a steam engine, steam-turbine, gas-turbine, or electric hybrid engine. It can completely replace gasoline, diesel, oil or gas engines in trucks, trains, submarines, ships, tanks etc. to increase efficiency at reduced or zero pollution, provided that the hydrogen is generated from or through renewable energy sources.

In one embodiment, said hydrogen hybrid cycle system 100 can be useful for both power generation and heat energy utilization. One such example, but not limited to this, is cane sugar production, in which said hydrogen hybrid cycle system 100 is used to generate electric power. The exhaust steam from the turbine can be used in industrial processing of cane sugar before or after being used in said heat recovery steam generator 112.

While the invention has been shown in only one of its forms, it is not thus limited but is flexible to various configurations and modifications without departing from the spirit thereof. In one alternative version, said cooling steam 146 by said combustion chamber 106 can be used in various industrial processes before or after being injected into said heat recovery steam generator 112. Possible industrial uses include conventional power plants, sugar production, and paper production

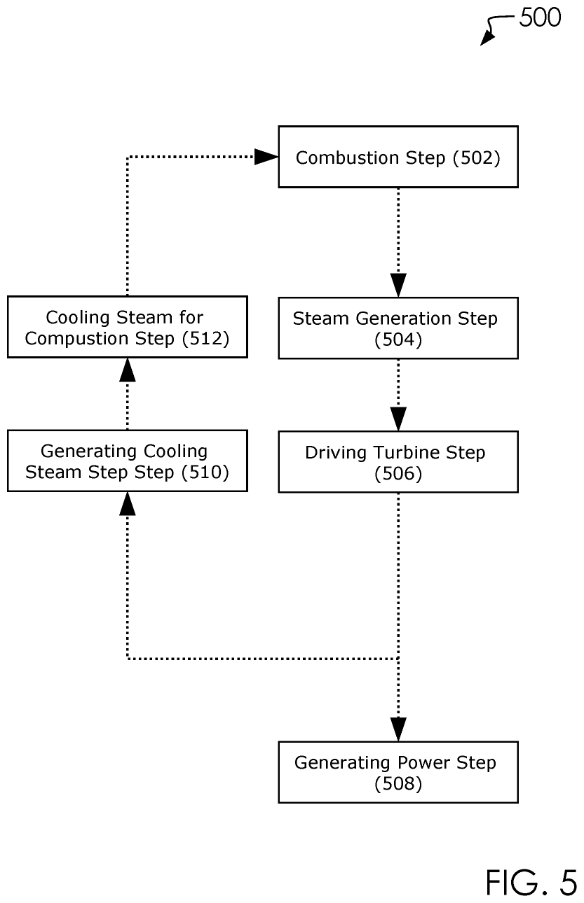

FIG. 5 illustrates a flow chart view of said power generation method 500.

In one embodiment, said power generation method 500 can comprise said combustion step 502, said steam generation step 504, said driving turbine step 506, said generating power step 508, said generating cooling steam step 510 and said cooling stream for combustion step 512.

In one embodiment, said power generation method 500 can comprise the steps for implementing said hydrogen hybrid cycle system 100 and said detailed cycle system 200, as discussed above

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.

1. A hydrogen hybrid cycle system configured to convert heat into mechanical work by burning a H2 and an O2, wherein:
said hydrogen hybrid cycle system comprises a H2 source, an O2 source, a combustion chamber, a first steam injected gas turbine, a load, a heat recovery steam generator and a water pump;
said H2 source provides said H2 to said combustion chamber;
said O2 source provides said O2 to said combustion chamber;
said combustion chamber burns portions of said H2 and said O2;
said hydrogen hybrid cycle system burns said H2 and said O2 at or near stoichiometry in said combustion chamber;
said hydrogen hybrid cycle system cools said combustion chamber with at least one of a cooling steam and a water;
said combustion chamber creates a generated steam;
said generated steam turns said first steam injected gas turbine; and
said first steam injected gas turbine is coupled said load.

2. The hydrogen hybrid cycle system from claim 1, wherein:
said H2 source comprises liquid hydrogen or hydrogen stored in gaseous phase under high pressure or at ambient pressure;
said H2 is stored in a containment selected among cylinders, geological storage, indirect form, or as a byproduct of industrial process;
said hydrogen hybrid cycle system further comprises a hydrogen pump;
said hydrogen pump is configured to deliver low pressure H2 as a gaseous phase at the necessary elevated pressure for operation before it enters said combustion chamber;
said hydrogen hybrid cycle system further comprises an hydrogen vaporizer; and
said hydrogen pump and said hydrogen vaporizer produce gaseous hydrogen from liquid hydrogen at a necessary pressure for operation before it enters said combustion chamber.

3. The hydrogen hybrid cycle system from claim 1, wherein:
said H2 comprises an impurity ratio;
said impurity ratio comprises an industrial standard of 99; and 9% pure hydrogen; and
said hydrogen hybrid cycle system is configured to accommodate said impurity ratio being below said industrial standard depending on a final temperature, a pressure, a quality and a usage of a generated steam by said combustion chamber.

4. The hydrogen hybrid cycle system from claim 1, wherein:
said O2 source comprises liquid oxygen or oxygen stored in gaseous phase under high pressure or at ambient pressure;
said O2 is stored in a containment selected among cylinders, geological storage, indirect form, or as a byproduct of industrial process;
said hydrogen hybrid cycle system further comprises an oxygen pump;
said oxygen pump is configured to deliver low pressure O2 as a gaseous phase at the necessary elevated pressure for operation before it enters said combustion chamber;
said hydrogen hybrid cycle system further comprises an oxygen vaporizer; and
said oxygen pump and said oxygen vaporizer produce gaseous oxygen from liquid oxygen at a necessary pressure for operation before it enters said combustion chamber.

5. The hydrogen hybrid cycle system from claim 1, wherein:
said O2 comprises an impurity ratio;
said impurity ratio comprises an industrial standard of ninety-nine point nine percent pure oxygen;
said impurity ratio comprises an industrial grade; and
said hydrogen hybrid cycle system is configured to accommodate said impurity ratio being below said industrial standard.

6. The hydrogen hybrid cycle system from claim 1, wherein:
a water reservoir stores said water; and
said water is demineralized with chemical additives.

7. The hydrogen hybrid cycle system from claim 1, wherein:
said hydrogen hybrid cycle system further comprising a feed water cooler;
said feed water cooler comprising a feed water to feed water cooler input passage, and a feed water to feed water cooler output passage;
said water reservoir feeds said water to said water pump through a second water passage;
said feed water to feed water cooler input passage pulls a portion of said water out of said second water passage;
said feed water cooler cools a portion of said water; and
said feed water to feed water cooler output passage returns a portion of said water back into said second water passage.

8. The hydrogen hybrid cycle system from claim 7, wherein:
said feed water cooler comprises a cooling equipment selected from among air cooling or hydrogen cooling.

9. The hydrogen hybrid cycle system from claim 7, wherein:
said feed water cooler is configured to optimize a temperature of said water to optimize said hydrogen hybrid cycle system.

10. The hydrogen hybrid cycle system from claim 1, wherein:
said combustion chamber receives:
said H2 from said H2 source through a H2 passage,
said O2 from said O2 source through an O2 passage,
said water from said water reservoir through said second water passage, and
said cooling steam from said heat recovery steam generator through a steam passage.

11. The hydrogen hybrid cycle system from claim 10, wherein:
said water from said water reservoir is converted to a pressurized water with said water pump.

12. The hydrogen hybrid cycle system from claim 11, wherein:
said combustion chamber is configured to burn said H2 and said O2 with said pressurized water, and said cooling steam.

13. The hydrogen hybrid cycle system from claim 1, wherein:
said heat recovery steam generator is configured to generate said cooling steam at multi-temperatures;
a multi-temperature cooling steams are delivered from said heat recovery steam generator to said combustion chamber through a one or more cooling steam passages;
said hydrogen hybrid cycle system further comprises a steam water mixer configured for:
receiving a portion of said multi-temperature cooling steams and said pressurized water,
mixing said multi-temperature cooling steams and said pressurized water to create a mixed steam water, and
delivering said mixed steam water into said combustion chamber through a mixed steam passage.

14. The hydrogen hybrid cycle system from claim 1, wherein:
said first steam injected gas turbine comprises one among a multi-stage turbines;
said multi-stage turbines comprises said first steam injected gas turbine, a second steam injected gas turbine, and a bypass steam passage;
said multi-stage turbines receives said generated steam from said combustion chamber into said first steam injected gas turbine and generates a reduced steam and powers said load;
said multi-stage turbines receives a reheated steam from said combustion chamber through a passage;
said reheated steam is fed into said second steam injected gas turbine and is converted into a turbine exit steam;
said reduced steam is reheated in said combustion chamber and comes out as said reheated steam; and
said reduced steam is configured to increase a power output of said multi-stage turbines.

15. The hydrogen hybrid cycle system from claim 14, wherein:
for operational flexibility in different configurations and loading conditions, said reduced steam can bypass the re-heater in said combustion chamber and be injected directly into said second steam injected gas turbine through said bypass steam passage.

16. The hydrogen hybrid cycle system from claim 14, wherein:
said multi-stage turbines are configured to reinject a portion of said reduced steam into said second steam injected gas turbine through said bypass steam passage.

17. The hydrogen hybrid cycle system from claim 1, wherein:
said heat recovery steam generator receives said turbine exit steam through a turbine exit steam passage.

18. The hydrogen hybrid cycle system from claim 17, wherein:
said turbine exit steam from said multi-stage turbines is harnessed in said heat recovery steam generator and used to convert said pressurized water into said cooling steam or said multi-temperature cooling steams.

19. The hydrogen hybrid cycle system from claim 17, wherein:
said heat recovery steam generator is configured to produce said multi-temperature cooling steams;
said multi-temperature cooling steams configured to increase heat recovery rate and cycle efficiency of said hydrogen hybrid cycle system;
said multi-temperature cooling steams comprises a low temp cooling steam, a medium temp cooling steam and a high temp cooling steam, as compared to one another, respectively;
a portion of said multi-temperature cooling steams is delivered to said combustion chamber through said one or more cooling steam passages; and
a remaining portion of said multi-temperature cooling steams is delivered to said steam water mixer through a one or more steam to steam water mixer passages.

20. The hydrogen hybrid cycle system from claim 1, wherein:
said heat recovery steam generator receives said pressurized water and said turbine exit steam;
said heat recovery steam generator generates said cooling steam from said pressurized water and heat from said turbine exit steam;
said heat recovery steam generator creates a residual steam from said turbine exit steam; and
said turbine exit steam and said pressurized water do not commingle with each other in said heat recovery steam generator.

21. The hydrogen hybrid cycle system from claim 1, wherein:
said hydrogen hybrid cycle system comprises a deaerator, an unburnt gas vent passage, and a water reservoir passage;
said deaerator receives said residual steam from said heat recovery steam generator through a passage;
said residual steam comprises condensate;
an unburnt gas is released from said deaerator into an atmosphere through said unburnt gas vent passage; and
said deaerator delivers a portion of said water to said water reservoir through said water reservoir passage.

22. The hydrogen hybrid cycle system from claim 1, wherein:
said hydrogen hybrid cycle system comprises said water pump, a first water passage, said second water passage and a water to heat recovery steam generator passage;
said water is pumped out of a water reservoir through said second water passage and into said water pump; and
said water is converted into a pressurized water in said water pump.

23. The hydrogen hybrid cycle system from claim 22, wherein:
said heat recovery steam generator produces said multi-temperature cooling steams; and
said water pump comprises a plurality of pumps configured to pump said water into said heat recovery steam generator at a desired pressure.

24. The hydrogen hybrid cycle system from claim 22, wherein:
said pressurized water is delivered to said combustion chamber in said first water passage and said heat recovery steam generator in said water to heat recovery steam generator passage.

25. The hydrogen hybrid cycle system from claim 1, wherein:
said steam water mixer receives said pressurized water from said water pump through a third water passage and said multi-temperature cooling steams from said heat recovery steam generator through a one or more steam to mixer passages;
said multi-temperature cooling steams and said pressurized water are mixed together by said steam water mixer into said mixed steam water;
said steam water mixer mists a portion of said pressurized water;
said steam water mixer vaporizes a portion of said pressurized water; and
said mixed steam water is delivered into said combustion chamber through said mixed steam passage.

26. The hydrogen hybrid cycle system from claim 25, wherein:
a portion of said water to heat recovery steam generator passage and said multi-temperature cooling steams entering said combustion chamber and said steam water mixer are optimized to operate said hydrogen hybrid cycle system at maximized cycle performance;
a portion of said water to heat recovery steam generator passage and said multi-temperature cooling steams entering said combustion chamber and said steam water mixer are optimized depending on safe and efficient operation of said hydrogen hybrid cycle system; and
a portion of said water to heat recovery steam generator passage and said multi-temperature cooling steams entering said combustion chamber and said steam water mixer are optimized depending on operational parameters in said hydrogen hybrid cycle system.

27. The hydrogen hybrid cycle system from claim 1, wherein:
said load is selected from among an AC generator, a DC generator, a transmission drive, one or more pumps, a one or more compressors, a locomotive, and one or more mechanical rotational loads.

28. The hydrogen hybrid cycle system from claim 1, wherein:
said cooling steam from said heat recovery steam generator is replaced with steam from an industrial process, bleed steam from a steam or gas turbine cycle, or steam generated by waste heat recovery of an industrial process.

29. The hydrogen hybrid cycle system from claim 28, wherein:
a steam being generated from another industrial process, comprising an appropriate pressure for said hydrogen hybrid cycle system, can be used instead of said cooling steam in said combustion chamber.

30. A power generation method for producing useful work through a hydrogen hybrid cycle system includes following stages, or components:
a combustion step, a steam generation step, a driving turbine step, a generating power step, a generating cooling steam step and a cooling stream for combustion step;
said combustion step comprises
receiving a H2 in a combustion chamber,
receiving an O2 in said combustion chamber, and
burning portions of said H2 and said O2 in said combustion chamber;
said steam generation step comprises
cooling said combustion chamber with a cooling steam and a water, and
generating a generated steam;
said driving turbine step comprises
driving a first steam injected gas turbine with said generated steam;
said generating power step comprises
generating said cooling steam with a heat recovery steam generator, and
delivering said cooling steam from said heat recovery steam generator to said combustion chamber through a one or more cooling steam passages;
said generating cooling steam step comprises
cooling said combustion chamber with said cooling steam;
wherein, said hydrogen hybrid cycle system comprises a H2 source, an O2 source, said combustion chamber, said first steam injected gas turbine, said heat recovery steam generator, a water pump, and a load;
said H2 source provides said H2 to said combustion chamber;
said O2 source provides said O2 to said combustion chamber;
said combustion chamber burns portions of said H2 and said O2;
said hydrogen hybrid cycle system burns said H2 and said O2 at or near stoichiometry in said combustion chamber;
said hydrogen hybrid cycle system cools said combustion chamber with said cooling steam and said water;
said combustion chamber creates said generated steam;
said first steam injected gas turbine is coupled with said load;
said combustion chamber receives
Said H2 from said H2 source through a H2 passage,
said O2 from said O2 source through an O2 passage,
said water from a water reservoir through a water reservoir passage, and
said cooling steam from said heat recovery steam generator through a steam passage.
